(19) United States
(12) Patent Application Publication
(10) Pub. No.: US 2016/0162105 A1
(43) Pub. Date: Jun. 9, 2016

(54) INPUT SYSTEM FOR A POINTING DEVICE

(71) Applicant: ALPS ELECTRIC CO., LTD., Tokyo (JP)

(72) Inventor: Hiroshi SHIGETAKA, Tokyo (JP)

(21) Appl. No.: 14/926,654

(22) Filed: Oct. 29, 2015

(30) Foreign Application Priority Data
Dec. 8, 2014 (JP) 2014-248314

(51) Int. Cl. G06F 3/041; G06F 3/038; G06F 3/044

(52) U.S. Cl. CPC G06F 3/0416; G06F 3/044; G06F 3/038; G06F 2203/04101; G06F 2203/04106

(57) ABSTRACT

In an input system, an arithmetic device includes a judgment unit that judges whether a pointing stick is electrically connected, the arithmetic device transmits, to a control unit, identification information indicating that the pointing stick does not exist if the pointing stick is not connected to the arithmetic device, the arithmetic device transmits, to the control unit, identification information indicating that the pointing stick exists if the pointing stick is connected to the arithmetic device, the control unit operates in a first mode in which control is performed based only on a first coordinate if the identification information indicating that the pointing stick does not exist is received, and the control unit operates in a second mode in which control corresponding to each of the first coordinate and a second coordinate is performed if the identification information indicating that the pointing stick exists is received.

### CLAIM OF PRIORITY

This application contains subject matter related to and claims the benefit of Japanese Patent Application No. 2014-248314 filed on Dec. 8, 2014, the entire contents of which is incorporated herein by reference.

### BACKGROUND OF THE DISCLOSURE

1. Field of the Disclosure

The present disclosure relates to an input system and in particular to an input system for a pointing device.

2. Description of the Related Art

In the past, in a portable electronic device such as a notebook computer or a mobile terminal, a pointing device such as a touch pad, a trackball, or a pointing stick is embedded as a coordinate input device, thereby establishing an input system.

As illustrated in FIG. 5, U.S. Pat. No. 8,711,120 discloses a technology for configuring a composite input device in which both a capacitive proximity sensing device (touch pad) 900 and a pointing stick 935 operate using one IC 905.

Generally, in portable electronic devices such as notebook computers, a variety of models whose functions and performances vary depending on intended purposes are prepared, and a model including a touch pad and a pointing stick and a model including only a touch pad are set in some cases.

However, in the above-mentioned related art, to cope with a variety of models, based on the presence or absence of such a pointing stick, is not taken into consideration.

To perform a work of, for example, installing, in a so-called dual type model including the touch pad and the pointing stick, a control program for the dual type and installing, in a so-called single type model including only the touch pad, a control program for the single type may be considered. In addition, it is necessary to attach the touch pad for the dual type in a case of the dual type, and it is necessary to attach the touch pad for the single type in a case of the single type. In other words, there has been a problem that it is necessary to perform works that vary depending on models, thereby leading to an increase in management man-hours.

These and other drawbacks exist.

### SUMMARY OF THE DISCLOSURE

Embodiments of the present disclosure solve the above-mentioned problem and provide an input system capable of reducing management man-hours while it is not necessary to perform works that vary depending on models.

According to various embodiments, an input system includes a touch pad configured to perform a first electric output corresponding to a first operation state, an arithmetic device configured to be able to perform, based on the first electric output, an arithmetic operation of a first coordinate, to be able to be electrically connected to a pointing stick to perform a second electric output corresponding to a second operation state, and to be able to perform, based on the second electric output, an arithmetic operation of a second coordinate, and a control unit configured to be able to control based on the first coordinate, to be able to control based on the second coordinate, and to perform control based on a control program, wherein the arithmetic device further includes a judgment unit configured to judge whether the pointing stick is electrically connected, the arithmetic device transmits, to the control unit, identification information indicating that the pointing stick does not exist in a case where the pointing stick is not connected to the arithmetic device, the arithmetic device transmits, to the control unit, identification information indicating that the pointing stick exists in a case where the pointing stick is connected to the arithmetic device, the control unit operates in a first mode in which control is performed based only on the first coordinate in a case where the identification information indicating that the pointing stick does not exist is received, and the control unit operates in a second mode in which control corresponding to each of the first coordinate and the second coordinate is performed in a case where the identification information indicating that the pointing stick exists is received.

According to these embodiments, it is possible to provide an input system capable of reducing management man-hours while it is not necessary to perform works that vary depending on models.

In addition, in the input system of the present disclosure, the arithmetic device may include a driving terminal electrically connectable to a driving end of a detection circuit in the pointing stick and a detecting terminal electrically connectable to a detecting end of the detection circuit in the pointing stick, the judgment unit may judge that the pointing stick is connected if an electric output is detected in the detecting terminal in a case of electrically driving the driving terminal, and the judgment unit may judge that the pointing stick is not connected if no electric output is detected in the detecting terminal in a case of electrically driving the driving terminal.

Accordingly, by driving the pointing stick, the presence or absence of the pointing stick may be judged based on the presence or absence of an electric output detected from the pointing stick. Therefore, it is possible to judge without providing another terminal for judgment.

### BRIEF DESCRIPTION OF THE DRAWINGS

FIGS. 1A and 1B are external schematic diagrams of devices to which an input system according to an example embodiment of the present disclosure is applied;

FIG. 2 is a block diagram illustrating a configuration of the input system according to an example embodiment of the present disclosure;

FIG. 3 is a diagram illustrating a configuration of a detection circuit and a connection with an example input system;

FIGS. 4A and 4B are flowcharts each illustrating an operation of the input system according to an example embodiment of the present disclosure; and

FIG. 5 is a diagram illustrating an input device of the related art.

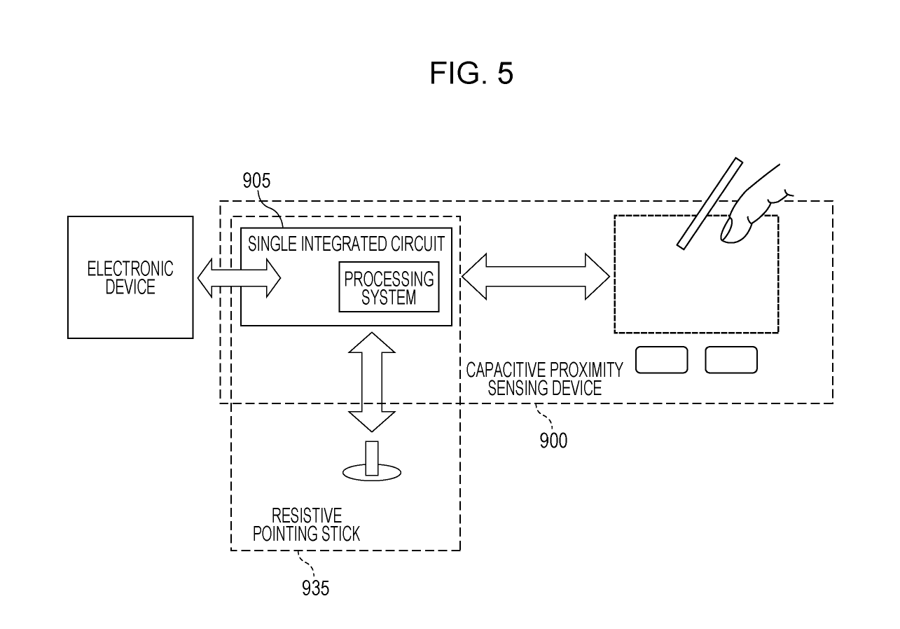

### DETAILED DESCRIPTION OF THE DISCLOSURE

The following description is intended to convey a thorough understanding of the embodiments described by providing a number of specific embodiments and details involving an input system. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

Hereinafter, an input system 100 in the present embodiment will be described.

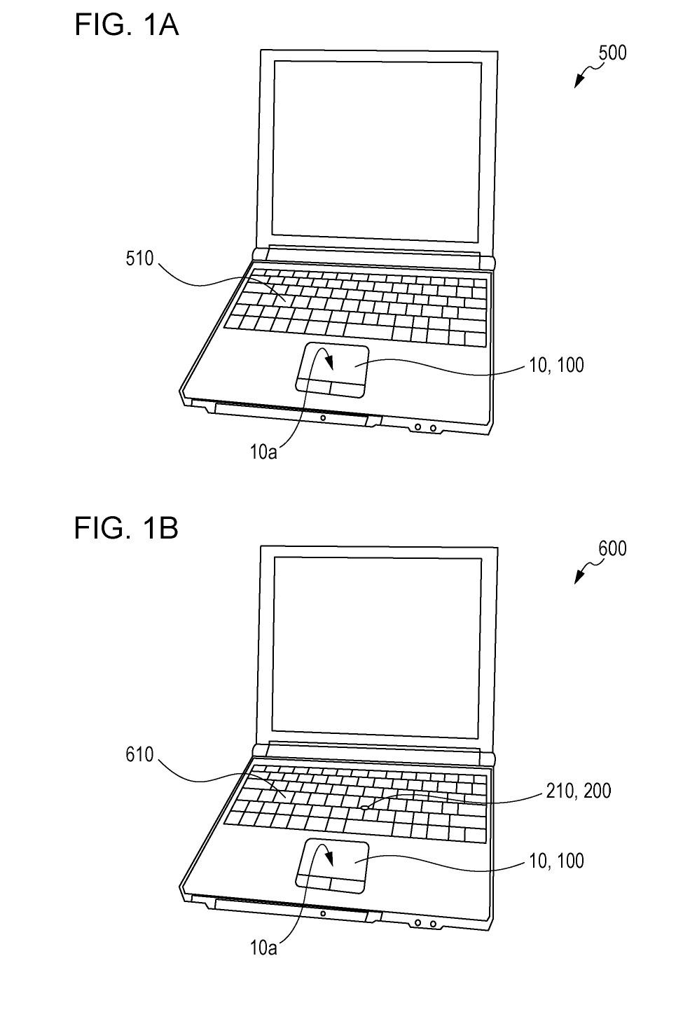

First, outlines of devices (500 and 600) to which the input system 100 in the present embodiment is applied will be described using FIGS. 1A and 1B. FIGS. 1A and 1B are external schematic diagrams of the devices (500 and 600) to which the input system 100 is applied, FIG. 1A is an external schematic diagram of the device 500 equipped with a touch pad 10, and FIG. 1B is an external schematic diagram of the device 600 in which both the touch pad 10 and a pointing stick 200 are provided.

As illustrated in FIG. 1A or FIG. 1B, in the device (500 or 600) to which the input system 100 is applied, an operation surface 10a is attached, in a state of being exposed, to the center of a palm rest portion in which the touch pad 10 is provided in front of a keyboard (510 or 610).

In the device 600 in which the both the touch pad 10 and the pointing stick 200 are provided, a circular cylindrical operation axis 210 of the pointing stick 200 is provided integrally with the keyboard 610, as illustrated in FIG. 1B.

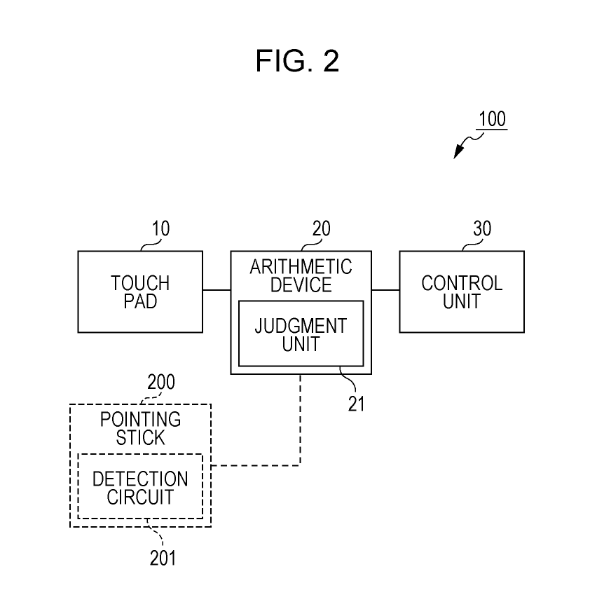

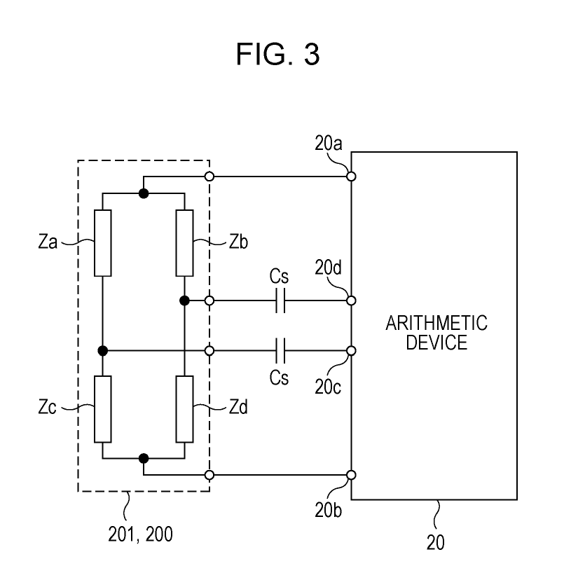

Next, a configuration of the input system 100 in an example embodiment will be described using FIGS. 1A and 1B to FIG. 3. FIG. 2 is a block diagram illustrating a configuration of the input system 100 according to an example embodiment of the present disclosure. FIG. 3 is a diagram illustrating a configuration of a detection circuit 201 in the pointing stick 200 and a connection with the input system 100.

As illustrated in FIG. 2, the input system 100 may include a touch pad 10, an arithmetic device 20, and a control unit 30.

As illustrated in FIG. 2, the touch pad 10 may be connected to the arithmetic device 20. In response to a first operation state in which an operation body such as a hand or a finger of an operator comes into contact with the operation surface 10a illustrated in FIG. 1A or FIG. 1B, thereby performing an operation, the touch pad 10 may convert a change in electric state such as electrostatic capacitance or a resistance value into a current, a voltage, or the like and performs a first electric output on the arithmetic device 20.

As illustrated in FIG. 2, the arithmetic device 20 may be connected to the touch pad 10 and the control unit 30, is configured so as to be electrically connectable to the pointing stick 200, and further includes a judgment unit 21. In addition, the arithmetic device 20 may include two driving terminals (20a and 20b) and two detecting terminals (20c and 20d) and be configured so as to be electrically connectable to respective driving ends and respective detecting ends of the detection circuit 201 provided in the pointing stick 200. The arithmetic device 20 may be able to perform, based on the first electric output by the touch pad 10, an arithmetic operation of a first coordinate, to perform, based on a second electric output by the pointing stick 200, an arithmetic operation of a second coordinate and so forth, and to store therein the results thereof. In addition, based on control performed by the control unit 30, the arithmetic device 20 may output, to the control unit 30, the first coordinate and second coordinate subjected to the arithmetic operations and stored.

As illustrated in FIG. 2, the control unit 30 may be connected to the arithmetic device 20. The control unit 30 may be equipped with a central processing unit (CPU), a memory, and a timer function, and a control program is preliminarily written to the memory. The control unit 30 may be able to control the arithmetic device 20 in accordance with the control program, to control based on the first coordinate, and to control based on the second coordinate, and the control unit 30 controls based on the first coordinate and second coordinate output by the arithmetic device 20.

Next, the pointing stick 200 connectable to the input system 100 will be described. In response to a second operation state in which the operator tilts the operation axis 210 illustrated in FIG. 1B, thereby performing an operation, the pointing stick 200 may convert a change in electric state such as electrostatic capacitance, a resistance value, or the like into a current, a voltage, or the like and performs a second electric output on the arithmetic device 20. As illustrated in FIG. 3, four strain sensors (Za, Zb, Zc, and Zd) may be bridge-connected, thereby configuring the detection circuit 201 in the pointing stick 200. The operation axis 210 may be subjected to the tilt operation and the stresses applied to the strain sensors (Za, Zb, Zc, and Zd) change, thereby causing a change in electric state such as electrostatic capacitance or a resistance value in each of the strain sensors (Za, Zb, Zc, and Zd), and the pointing stick 200 may convert the change into a current, a voltage, or the like.

A connection in a case where the pointing stick 200 is electrically connected to the arithmetic device 20 will be described using FIG. 3. As illustrated in FIG. 3, a connection point between the strain sensor Za and the strain sensor Zb may be connected, as one of two driving ends, to the driving terminal 20a on one of two sides, and a connection point between the strain sensor Zc and the strain sensor Zd is connected, as the other driving end, to the driving terminal 20b on the other side. In addition, a connection point between the strain sensor Za and the strain sensor Zc may be connected, as one of two detecting ends, to the detecting terminal 20c on one of two sides via one of two capacitors Cs, and a connection point between the strain sensor Zb and the strain sensor Zd may be connected, as the other detecting end, to the detecting terminal 20d on the other side via the other capacitor Cs.

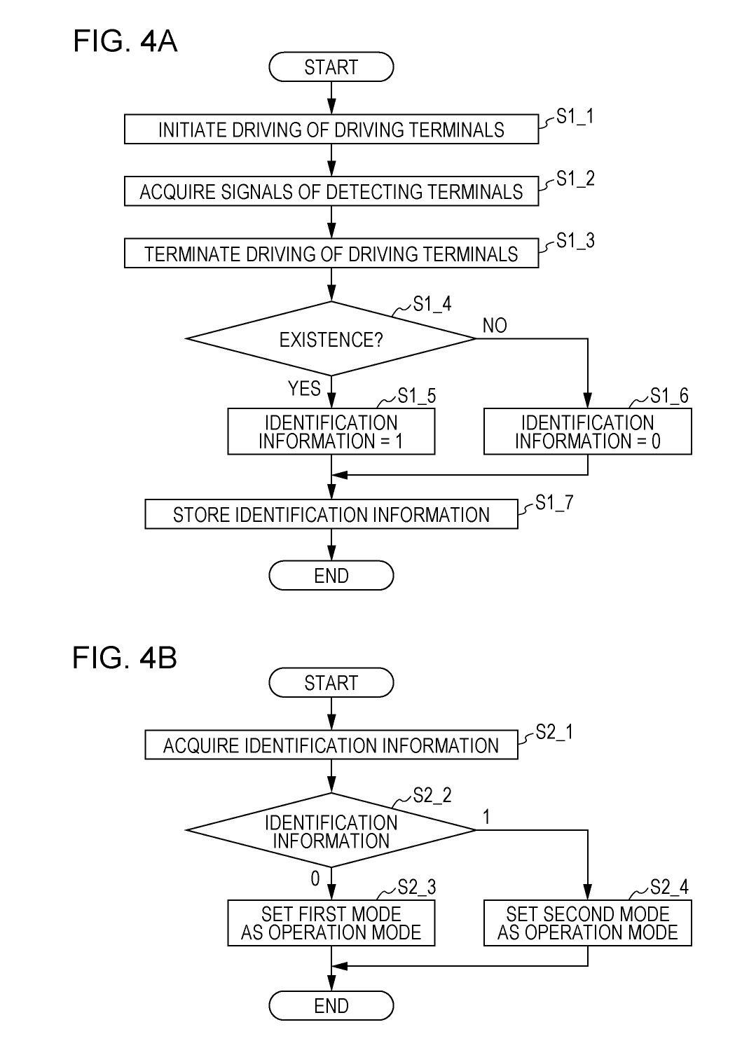

Next an operation of the input system 100 will be described using FIGS. 4A and 4B. FIGS. 4A and 4B are flowcharts each illustrating an operation of the input system 100. FIG. 4A may be a flowchart illustrating a control procedure in a case where the judgment unit 21 in the arithmetic device 20 judges whether the pointing stick 200 is electrically connected, and FIG. 4B may be a flowchart illustrating a control procedure in the control unit 30.

First, an operation of the judgment unit 21 provided in the arithmetic device 20 will be described using FIG. 4A. The processing procedure of the flowchart illustrated in FIG. 4A may be performed by the judgment unit 21 in a case where power is supplied to the arithmetic device 20 in the input system 100 and the arithmetic device 20 initiates an operation.

In a procedure S1_1, the judgment unit 21 may output driving signals for electrically driving the driving terminal 20a on one side and the driving terminal 20b on the other side in the arithmetic device 20 and may make a transition to a procedure S1_2. As for the driving signals, a pulse signal having, for example, a constant period may be output to the driving terminal 20a on one side, and a ground potential (0 V) or the same potential as that of a supplied power source may be output, as a reference potential, to the driving terminal 20b on the other side. Note that the signal output to the driving terminal 20a on one side and the signal output to the driving terminal 20b on the other side may be replaced with each other.

In the procedure S1_2, the judgment unit 21 may acquire signals of the detecting terminals (20c and 20d) in the procedure S1_2 and may make a transition to a procedure S1_3.

In the procedure S1_3, the judgment unit 21 may halt the driving signals output in the procedure S1_1 and may make a transition to a procedure S1_4.

In a case where, in the procedure S1_4, the signals of the detecting terminals (20c and 20d) acquired in the procedure S1_2 are signals based on electric outputs detected in a case of electrically driving the driving terminals (20a and 20b) in the procedure S1_1, the judgment unit 21 may judge that the pointing stick 200 is connected, and the judgment unit 21 may make a transition to a procedure S1_5.

In addition, if no signals based on electric outputs are detected at the detecting terminals (20c and 20d) in a case of electrically driving the driving terminals (20a and 20b), the judgment unit 21 may judge that the pointing stick 200 is not connected, and the judgment unit 21 may make a transition to a procedure S1_6. As described above, the judgment unit 21 in the arithmetic device 20 may judge whether the pointing stick 200 is electrically connected.

In the procedure S1_5, the judgment unit 21 may set “1” as identification information indicating that the pointing stick 200 exists, and the judgment unit 21 may make a transition to a procedure S1_7.

In the procedure S1_6, the judgment unit 21 may set “0” (zero) as identification information indicating that the pointing stick 200 does not exist, and the judgment unit 21 may make a transition to the procedure S1_7.

In the procedure S1_7, the judgment unit 21 may store the identification information set in the procedure S1_5 or the procedure S1_6 and terminates the processing procedure. Note that, based on control performed by the control unit 30, the stored identification information may be transmitted to the control unit 30 by the arithmetic device 20.

Next, an operation of the control unit 30 will be described using FIG. 4B. The processing procedure of the flowchart illustrated in FIG. 4B is performed by the control unit 30 in the input system 100.

In a procedure S2_1, the control unit 30 may control the arithmetic device 20 and may cause the identification information to be transmitted to the control unit 30, thereby acquiring the identification signal, and the control unit 30 may make a transition to a procedure S2_2.

In the procedure S2_2, the control unit 30 may check a value set in the identification information acquired in the procedure S2_1, and in a case where “0” (zero) indicating that the pointing stick 200 is not connected to the arithmetic device 20 is set in the received identification information, the control unit 30 may make a transition to a procedure S2_3. In addition, “1” indicating that the pointing stick 200 is connected to the arithmetic device 20 is set in the received identification information, the control unit 30 may make a procedure S2_4.

The procedure S2_3 may correspond to a case where, in the procedure S2_2, it is determined that the identification information indicating that the pointing stick 200 does not exist is received. In the procedure S2_3, the control unit 30 may perform a setting so as to operate in a first mode in which control is performed based only on the first coordinate, and the control unit 30 terminates setting processing of an operation mode. In addition, after that, the input system 100 operates in a first operation mode.

The procedure S2_4 may correspond to a case where, in the procedure S2_2, it is determined that the identification information indicating that the pointing stick 200 exists is received. In the procedure S2_4, the control unit 30 may perform a setting so as to operate in a second mode in which control corresponding to each of the first coordinate and the second coordinate is performed, and the control unit 30 terminates setting processing of the operation mode. In addition, after that, the input system 100 operates in a second operation mode.

The input system 100 of the present disclosure may include a touch pad 10 configured to perform the first electric output corresponding to the first operation state, the arithmetic device 20 configured to be able to perform, based on the first electric output, an arithmetic operation of the first coordinate, to be able to be electrically connected to the pointing stick 200 to perform the second electric output corresponding to the second operation state, and to be able to perform, based on the second electric output, an arithmetic operation of the second coordinate, and the control unit 30 configured to be able to control based on the first coordinate, to be able to control based on the second coordinate, and to perform control based on the control program, wherein the arithmetic device 20 further includes the judgment unit 21 configured to judge whether the pointing stick is electrically connected, the arithmetic device 20 transmits, to the control unit 30, the identification information indicating that the pointing stick 200 does not exist in a case where the pointing stick 200 is not connected to the arithmetic device 20, the arithmetic device 20 transmits, to the control unit 30, the identification information indicating that the pointing stick 200 exists in a case where the pointing stick 200 is connected to the arithmetic device, the control unit 30 operates in the first mode in which control is performed based only on the first coordinate in a case where the identification information indicating that the pointing stick 200 does not exist is received, and the control unit 30 operates in the second mode in which control corresponding to each of the first coordinate and the second coordinate is performed in a case where the identification information indicating that the pointing stick 200 exists is received.

From this, the arithmetic device 20 transmits, to the control unit 30, the identification information indicating the presence or absence of the pointing stick 200. Accordingly, it is possible for the control unit 30 to automatically switch an operation mode, based on the identification information. Therefore, it is possible to provide an input system capable of reducing management man-hours while it is not necessary to perform works that vary depending on models.

In addition, in the input system 100 of the present disclosure, the arithmetic device 20 may include the driving terminals (20a and 20b) electrically connectable to the driving ends of the detection circuit 201 in the pointing stick 200 and the detecting terminals (20c and 20d) electrically connectable to the detecting ends of the detection circuit 201 in the pointing stick 200, the judgment unit 21 may judge that the pointing stick 200 is connected if electric outputs are detected in the detecting terminals (20c and 20d) in a case of electrically driving the driving terminals (20a and 20b), and the judgment unit 21 may judge that the pointing stick 200 is not connected if no electric outputs are detected in the detecting terminals (20c and 20d) in a case of electrically driving the driving terminals (20a and 20b).

From this, by driving the pointing stick 200, the presence or absence of the pointing stick 200 may be judged based on the presence or absence of electric outputs detected from the pointing stick 200. Therefore, it is possible to judge without providing another terminal for judgment.

While, as described above, the input system according to an embodiment of the present disclosure is specifically described, the present invention is not limited to the above-mentioned embodiment and may be variously modified and implemented without departing from the scope thereof. For example, the input system may be altered and implemented as follows, and these embodiments belong to the technical scope of the present invention.

(1) While, in the present embodiment, the control unit 30 is described using an example of including the CPU, the memory, and the timer function, the control unit 30 may be configured using a micro processing unit (MPU). In such a case, it is preferred that the control program is implemented as firmware. In addition, the control unit corresponds to a control device or a storage device, configured by a CPU or the like mounted in a device such as a notebook PC, and the control program may be configured as a program for a driver, executed by a control device in the notebook PC.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

1. An input system comprising:
a touch pad that performs a first electric output corresponding to a first operation state;
an arithmetic device that performs, based on the first electric output, an arithmetic operation of a first coordinate, is electrically connected to a pointing stick to perform a second electric output corresponding to a second operation state, performs, based on the second electric output, an arithmetic operation of a second coordinate; and
a control unit that controls based on the first coordinate, controls based on the second coordinate, and performs control based on a control program, wherein
the arithmetic device further includes a judgment unit configured to judge whether the pointing stick is electrically connected,
the arithmetic device transmits, to the control unit, identification information indicating that the pointing stick does not exist in a case where the pointing stick is not connected to the arithmetic device, and the arithmetic device transmits, to the control unit, identification information indicating that the pointing stick exists in a case where the pointing stick is connected to the arithmetic device,
the control unit operates in a first mode in which control is performed based only on the first coordinate in a case where the identification information indicating that the pointing stick does not exist is received, and
the control unit operates in a second mode in which control corresponding to each of the first coordinate and the second coordinate is performed in a case where the identification information indicating that the pointing stick exists is received.

2. The input system according to claim 1, wherein
the arithmetic device includes a driving terminal electrically connectable to a driving end of a detection circuit in the pointing stick and a detecting terminal electrically connectable to a detecting end of the detection circuit in the pointing stick, and
the judgment unit judges that the pointing stick is connected if an electric output is detected in the detecting terminal in a case of electrically driving the driving terminal, and the judgment unit judges that the pointing stick is not connected if no electric output is detected in the detecting terminal in a case of electrically driving the driving terminal.
